(19) United States
(12) Patent Application Publication
(10) Pub. No.: US 2017/0121578 A1
(43) Pub. Date: May 4, 2017

(54) Polyurethane Laminating Adhesive Containing Filler

(71) Applicant: Henkel AG & Co. KGaA, Duesseldorf (DE)

(72) Inventors: Helga Garmann, Hilden (DE); Dennis Bankmann, Duesseldorf (DE); Marcel Franken, Neunkirchen-Seelscheid (DE); Jens Groitl, Alsdorf (DE)

(21) Appl. No.: 15/384,502

(22) Filed: Dec. 20, 2016

Related U.S. Application Data
(63) Continuation of application No. PCT/EP2015/064912, filed on Jul. 1, 2015.

(30) Foreign Application Priority Data
Jul. 4, 2014 (DE) 10 2014 212 999.0

(51) Int. Cl. C09J 175/04; B32B 15/04; B32B 27/40; C09J 175/06; B32B 7/12

(52) U.S. Cl. CPC C09J 175/04; C09J 175/06; B32B 7/12; B32B 27/40; B32B 15/04; C08K 3/26

(57) ABSTRACT

The present invention relates to a polyurethane adhesive, in particular for laminating multilayer films, wherein the PU adhesive contains—based on the total weight of the adhesive—5 to 50 wt %, preferably 10 to 40 wt %, particularly preferably 20 to 30 wt % of at least one solid particulate filler, wherein at least 90% of the filler particles of the at least one filler has a particle size of 4 μm or less, and the at least one filler has a Mohs hardness of 3 or less. The present invention also relates to the use of the adhesive for adhering films, to methods for producing composite films, and to composite films adhered using the aforementioned adhesive.

The present invention relates to a polyurethane adhesive, in particular for laminating films, wherein the PU adhesive contains fillers. The present invention further relates to use of said adhesive for adhesively bonding films, to methods for producing composite films, and to composite films adhesively bonded with said adhesive.

Laminating adhesives are generally known in industry. They are solvent-containing or solvent-free, crosslinking or physically setting adhesives which serve to bond thin, two-dimensional substrates, such as for example plastics films, metal foils, paper, or cardboard, to one another. It is essential here that the adhesive bond only slightly reduces the flexibility of the thin individual layers, while still achieving sufficient adhesion. Selection of the individual film layers makes it possible to influence specific characteristics of these multilayer films, in particular permeability to water or other liquids, chemical resistance, and permeability to oxygen or other gases.

Such multilayer films are used, for example, to produce packaging for foodstuffs in solid, pasty, or liquid form, plastic cutlery, medical materials, chemical products, cosmetics, cleaning agents, or articles. Such laminates are also used for technical products such as, for example, flexible conductors, electrical isolation materials, sails, or components for photovoltaics.

The aforementioned foodstuff applications result in the multilayer films being free of materials that migrate in harmful quantities from the packaging into the packaged goods. it is also desirable for the multilayer films to have an attractive visual appearance.

In the prior art, in particular, two-component systems without fillers are known as adhesives for such applications. These two-component systems are mixed prior to use, and then applied to a film to be adhered in quantities of typically around 1 to 5 g/m². The lamination of the second film onto the side of the first film that has been coated with the adhesive makes it possible to obtain, after curing, composite films that are used as packaging material, in particular, for foodstuffs but also for the other aforementioned uses. Such adhesive systems are usually transparent and the individual components are usually readily miscible with one another.

Known systems have disadvantages, however, in that occasionally, due to chemical or physical incompatibility between the two components, only insufficient mixture can be achieved, leading to problems in the adhesion. Further disadvantages are the facts that such systems have comparatively high costs and are produced essentially from petroleum products. Finally, some of the known systems have low viscosity, a result of which is that these systems interact with and smear printing inks on the films, and penetrate deep into the dye, so that larger quantities are required for adhesion.

The present invention therefore addresses the problem of providing polyurethane adhesives that do not have the aforementioned disadvantages.

It has surprisingly been discovered that the aforementioned disadvantages can be overcome through the use of special fillers in the known adhesive systems. The fillers used therefor must have a very small particle size, on the one hand, in order to be suitable for thin adhesive layer thicknesses of less than 5 μm, typically around 2 μm. On the other hand, the fillers must have certain properties with respect to the hardness and wetting behavior thereof. The corresponding filler-containing adhesive compositions are distinguished by having, on the one hand, a significantly improved miscibility of incompatible components. In addition, the use of such fillers makes it possible to dramatically lower the costs of the adhesive compositions, because the fillers are less expensive to obtain than the raw materials of the adhesive systems. Furthermore, the use of such fillers makes it possible to “bind” systems of very low viscosity, so as to reduce the penetration of the adhesives into the (printed) films. The fillers are moreover usually not petroleum based and are therefore resource-conserving. Finally, it has been surprisingly found that the use of fillers only barely noticeably reduces the transparency of the adhesive layer, and lower permeability to high-energy radiation enables better protection of the packaged goods—in particular, foodstuffs—against exposure to light.

In a first aspect, the present invention therefore relates to a polyurethane-based laminating adhesive composition, in particular, for laminating films, which—relative to the total weight thereof—contains 5 to 50 wt %, preferably 10 to 40 wt %, especially preferably 20 to 30 wt % of at least one solid particulate filler, wherein
a) at least 90% of the filler particles of the at least one filler have a particle size of 4 μm or less, and
b) the at least one filler has a Mohs hardness of 3 or less. In another aspect, the present invention relates: to a method for producing composite films, in which at least two identical or different plastic films are adhered with the use of a laminating adhesive composition such as described herein; and to correspondingly-produced composite films.

The present invention also encompasses the use of composite films produced in this manner as packaging, in particular, for the packaging of medicines or foodstuffs.

In yet another aspect, the present invention relates to the use of the laminating adhesive compositions described herein to adhere films.

The molecular weights set forth in the present text refer to the number-average molecular weight (Mn), unless otherwise specified. The molecular weight Mn can be determined on the basis of an end group analysis (hydroxyl value according to DIN 53240-1:2013-06), or by gel permeation chromatography (GPC) according to DIN 55672-1:2007-08 with THF as the eluent. Molecular weights set forth are ones that have been determined by GPC, unless otherwise specified. The weight-average molecular weight Mw can also be determined by means of GPC, as stated above.

“At least one” with reference to a component refer to the type of the component, and not to the absolute number of molecules. Thus, “at least one polyol” means, for example, at least one type of polyol, i.e., that one type of polyol or a mixture of a plurality of different polyols can be used. Together with references to weight, references designate all compounds of the relevant type that are contained in the composition/mixture, i.e., that the composition contains no further compounds beyond the given amount of corresponding compounds.

All percentages mentioned in connection with the compositions described herein refer to wt %, each with reference to the relevant mixture, unless explicitly stated otherwise.

“About,” “around,” or “approximately” as used herein in connection with a numerical value refer to the numerical value ±10%, preferably ±5%.

The fillers used are solid particles of an organic or inorganic compound or mixture of different compounds when at room temperature (20° C.) and atmospheric pressure (1013 mbar). The fillers preferably involve salts or minerals. The fillers used are distinguished in that at least 90% of the filler particles have a particle size of 4 μm or smaller (×90≦4 μm). Preferably, at least 50% of the filler particles have a particle size of 1.5 μm or smaller (×50≦1.5 μm). It is especially preferable when at least 10% of the filler particles have a particle size of 0.3 μm or smaller (×10≦0.3 μm). Fillers that fulfill all three criteria—i.e., have a particle size distribution of ×10≦0.3 μm, ×50≦1.5 μm, and ×90≦4 μm—are especially preferable. The terms ×10, ×50, or ×90 designate the 10th percentile, 50th percentile, and 90th percentile (respectively) of the particle size distribution. For example, ×90=4 signifies that 90% of the particles have a particle size of 4 μm or smaller, and 10% of the particles have a particle size of more than 4 μm. Correspondingly, ×90≦4 signifies that at least 90% of the particles have a particle size of 4 μm or smaller, and at most 10% of the particles have a particle size of more than 4 μm. There are a variety of methods available to determine the particle size or particle size distribution, inter alia, sieve analysis (according to IS0787, section 7), sedimentation analysis (according to DIN 661 15), and determination by means of laser light diffraction according to the standard ISO 13320:2009(E) (corrected version dated Dec. 1, 2009). The determination is performed according to the standard ISO 13320:2009(E), unless otherwise specified. The calibration is then based on standardized spherical reference materials—so-called spherical certified reference materials (CRMs)—of a known particle size distribution. The particle size of the spherical reference material refers to the particle diameter of the spherical reference material. The quantity given in percent (%) quantile refers to the volume fraction (vol %), according to the standard ISO 13320:2009(E).

It is furthermore preferable for the fillers to be present as essentially spherical particles, i.e., in particular, not as plates or pins/fibers. In different embodiments, the fillers are therefore not phyllosilicates or similar minerals. It is preferable for the fillers to be present as grains or crystallites, in particular, with a nearly spherical shape, i.e., an aspect ratio of about 1:1.

The particle size is significant in terms of the layer thickness of the adhesive layer. Because the typical adhesive layers in composite films have a thickness in the range of only 1 to 5 μm, it is important that the fillers have particle sizes that are compatible with such low small thicknesses, i.e., have mean particle sizes that do not exceed these thicknesses. Fillers typically used in the prior art usually have mean particle sizes of 25 μm and larger, and are therefore not suitable for the described laminating adhesives. Nanoparticles, in turn, are even less suitable, for cost reasons as well as any still-unresolved health hazards and the influence on the viscosity. It is therefore preferable according to the present invention for the fillers not to be nanoparticles and not to contain any nanoparticles in excess of the content that occurs naturally. It is therefore preferable for the composition to contain a filler that has a content of filler particles with a particle size ≦0.1 μm of at most 5%, relative to the filler. The at least one filler thus preferably has a particle size distribution of ×5≧0.1 μm. It is therefore especially preferable for the at least one filler to have a particle size distribution of ×10≦0.3 μm, ×50≦1.5 μm, ×90≦4 μm, and ×5≧0.1 μm.

The fillers used have a Mohs hardness of 3 or less. This ensures that the filler-containing adhesive compositions are compatible with the laminating machines commonly used. A greater hardness is detrimental in terms of abrasiveness, because a greater hardness can lead to damage to the rollers used in common lamination processes.

The Mohs hardness is determined by comparison of a given substance with a reference material to which a numerical value of 1 to 10 has been assigned in an ordinal scale (Mohs scale). The scale is based on the fact that softer minerals can be scratched by harder minerals, but the inverse is not true. The hardness differences between the individual reference minerals are not linear. The reference materials are talc with a Mohs hardness of 1, gypsum with a Mohs hardness of 2, calcite with a Mohs hardness of 3, fluorite with a hardness of 4, apatite with a hardness of 5, feldspar with a hardness of 6, quartz with a hardness of 7, topaz with a hardness of 8, corundum with a hardness of 9, and diamond with a hardness of 10. When the hardness of a given substance is being determined, the substance is used to scratch different reference materials having increasing hardnesses until no further scratching of the reference materials is possible. The hardness of the reference material that could no longer be scratched is then assigned to that substance.

In different embodiments, the filler has an oil absorption value of 50 or less, preferably 40 or less, still more preferably 25 or less. The oil absorption value can be determined by means of DIN EN ISO 787-5: 1995-10. The oil absorption value, also called the oil adsorption or OA, sets forth the amount of dropwise-added linseed oil (fixed quality, acid value about 2.8 mg KOH/g) that is adsorbed by a certain amount of filler when kneaded with a spatula on a glass plate until reaching the wetting point. The oil absorption value is a measure of the system compatibility, wherein a low oil absorption value signifies better compatibility with the adhesive system being used.

Fillers that are suitable according to the present invention include but are not limited to calcium carbonate, calcium sulfate, dolomite (CaMg(CO₃)₂), and mixtures of the foregoing. Calcium carbonate is particularly preferred. Tests to determine migration have surprisingly shown that the systems described herein, which contain calcium carbonate, release less primary aromatic amines (PAA) than otherwise identical systems with other fillers, e.g., talc, or than otherwise identical systems without fillers. Such PAAs arise when polyurethanes are cured, from free polyisocyanates that react off under the influence of moisture into the corresponding amines. Because PAAs are considered to be harmful, it is desirable to reduce or prevent the formation thereof or the migration thereof into packaged goods. In the further course of the curing, the intermediately-formed PAAs do react to completion with an isocyanate excess, but the more PAAs are formed in the intermediate stage, the longer the time required to achieve an essentially “migration-free” composite.

Moreover, it has surprisingly been shown that despite the addition of these non-reactive components, rather than decreasing the bonding adhesion of selected systems, the use of fillers may even in some cases increase the bonding adhesion. This means that the use of fillers makes it possible to improve the performance of the adhesives. The mechanical properties, too, can be improved. It has thus been found that calcium carbonate can raise the tension of adhesive systems at constant expansion.

Polyurethane adhesives are generally known. They are also used for laminating multilayer films. The adhesives suitable according to the present invention are one-component polyurethane adhesives or two-component polyurethane adhesives. The adhesives may be liquid, but may also be hot-melt adhesives. The adhesives may contain solvents, but are preferably solvent-free. Crosslinking of the polyurethane adhesives suitable according to the present invention is based on the reaction of reactive NCO groups with H-acidic functional groups, e.g., OH groups, amino groups, or carboxyl groups. An alternative crosslinking method involves the reaction of the NCO groups with moisture from the applied adhesive, the substrate, or the surroundings with formation of urea groups. These cross-linking reactions are known and they may also proceed concurrently. The adhesives conventionally contain catalysts, for example amine, titanium, or tin catalysts, to accelerate such reactions.

In preferred embodiments, the adhesive is a two-component polyurethane adhesive. Such an adhesive may contain at least one NCO-reactive, in particular, hydroxy-terminated polyurethane prepolymer as a resin component and at least one polyisocyanate as a curative component, or at least one NCO-terminated polyurethane prepolymer as a resin component and at least one polyol as a curative component. The latter systems are especially preferable according to the present invention.

In such two-component systems, the filler may be contained either in the resin component or in the curative component, or in both, but is contained, in particular, in the curative component. The resin component may then be free of fillers.

The isocyanate (NCO)-terminated PU prepolymers of the resin component are obtained by reacting a polyol or a polyol mixture with a stoichiometric excess of polyisocyanate. The polyols used in the preparation of the prepolymer may be any and all polyols commonly used for polyurethane synthesis, e.g., polyols, polyester polyols, polyether polyols, polyester ether polyols, polycarbonate polyols, or mixtures of two or more of the foregoing.

Polyether polyols can be produced from a large number of alcohols which contain one or more primary or secondary alcohol groups. As initiators for the production of the tertiary amino group-free polyethers, the following compounds, for example, or mixtures of these compounds, may be used: water, ethylene glycol, propylene glycol, glycerol, butanediol, butanetriol, trimethylolethane, pentaerythritol, hexanediol, 3-hydroxyphenol, hexanetriol, trimethylolpropane, octanediol, neopentyl glycol, 1,4-hydroxymethylcyclohexane, bis(4-hydroxyphenyl) dimethylmethane, and sorbitol. Ethylene glycol, propylene glycol, glycerol, and trimethylolpropane are preferably used, particularly preferably ethylene glycol and propylene glycol, and in a particularly preferred exemplary embodiment, propylene glycol is used.

Suitable as cyclic ethers for the production of the polyethers described above are alkylene oxides, such as ethylene oxide, propylene oxide, butylene oxide, epichlorohydrin, styrene oxide, or tetrahydrofuran, or mixtures of these alkylene oxides. The use of propylene oxide, ethylene oxide or tetrahydrofuran or mixtures of these is preferred. Propylene oxide or ethylene oxide or mixtures thereof are particularly preferably used. Propylene oxide is most particularly preferably used.

Polyester polyols may be produced, for example, by reacting low molecular weight alcohols, in particular ethylene glycol, diethylene glycol, neopentyl glycol, hexanediol, butanediol, propylene glycol, glycerol, or trimethylolpropane with caprolactone. Also suitable as polyfunctional alcohols for producing polyester polyols are 1,4-hydroxymethylcyclohexane, 2-methyl-1,3-propanediol, 1,2,4-butanetriol, triethylene glycol, tetraethylene glycol, polyethylene glycol, dipropylene glycol, polypropylene glycol, dibutylene glycol, and polybutylene glycol.

Other suitable polyester polyols can be produced by polycondensation. For instance, difunctional and/or trifunctional alcohols can be condensed with a substoichiometric quantity of dicarboxylic acids or tricarboxylic acids, mixtures of dicarboxylic acids or tricarboxylic acids, or reactive derivatives thereof, to form polyester polyols. Suitable dicarboxylic acids are, for example, adipic acid or succinic acid and higher homologues thereof with up to 16 C atoms, and also unsaturated dicarboxylic acids, such as maleic acid or fumaric acid, as well as aromatic dicarboxylic acids, in particular the isomeric phthalic acids, such as phthalic acid, isophthalic acid or terephthalic acid. Examples of suitable tricarboxylic acids include citric acid or trimellitic acid. The aforementioned acids can be used individually or as mixtures of two or more thereof. Particularly suitable alcohols are hexanediol, butanediol, ethylene glycol, diethylene glycol, neopentyl glycol, 3-hydroxy-2,2-dimethylpropyl 3-hydroxy-2,2-dimethylpropanoate, or trimethylolpropane, or mixtures of two or more thereof. Particularly suitable acids are phthalic acid, isophthalic acid, terephthalic acid, adipic acid, or dodecanedioic acid or mixtures thereof. Polyester polyols with high molecular weight include, for example, the reaction products of polyfunctional, preferably difunctional, alcohols (optionally together with small quantities of trifunctional alcohols) and polyfunctional, preferably difunctional, carboxylic acids. Instead of free polycarboxylic acids, (if possible) the corresponding polycarboxylic anhydrides or corresponding polycarboxylic acid esters with alcohols having preferably 1 to 3 C atoms can also be used. The polycarboxylic acids may be aliphatic, cycloaliphatic, aromatic, or heterocyclic, or both. They may optionally be substituted, for example by alkyl groups, alkenyl groups, ether groups, or halogens. Examples of suitable polycarboxylic acids include succinic acid, adipic acid, suberic acid, azelaic acid, sebacic acid, dodecanedioic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid, or trimer fatty acid, or mixtures of two or more thereof.

Polyesters obtainable from lactones, for example based on ε-caprolactone, also known as “polycaprolactones,” or hydroxycarboxylic acids, for example ω-hydroxycaproic acid, can also be used.

It is, however, also possible to use polyester polyols of oleochemical origin. Such polyester polyols may, for example, be produced by complete ring opening of epoxidized triglycerides of a fat mixture containing at least in part an olefinically unsaturated fatty acid with one or more alcohols having 1 to 12 C atoms and subsequent partial transesterification of the triglyceride derivatives to yield alkyl ester polyols having 1 to 12 C atoms in the alkyl residue.

Polycarbonate polyols may, for example, be obtained by the reaction of diols, such as propylene glycol, 1,4-butanediol or 1,6-hexanediol, diethylene glycol, triethylene glycol or tetraethylene glycol or mixtures of two or more of these diols with diaryl carbonates, for example diphenyl carbonates, or phosgene.

The molecular weight of the polyols used to synthesize the prepolymer is preferably in the range of 100 to 20000 g/mol, in particular, 330 to 4500 g/mol. The mean functionality may be in the range of 2 to 4.5. The PU prepolymer preferably has a polyether/polyester backbone.

The stoichiometric excess of polyisocyanate is—in relation to the molar ratio of NCO groups to OH groups—in particular, 1:1 to 1.8:1, preferably 1:1 to 1.6:1, and especially preferably 1.05:1 to 1.5:1.

The known coating material or adhesive polyisocyanates may be used, these entailing polyisocyanates having two or more isocyanate groups. Suitable polyisocyanates are for example 1,5-naphthylene diisocyanate (NDI), 2,4- or 4,4′-diphenylmethane diisocyanate (MDI), hydrogenated MDI (H12MDI), xylylene diisocyanate (XDI), tetramethylxylylene diisocyanate (TMXDI), di- and tetraalkylene diphenylmethane diisocyanate, 4,4′-dibenzyl diisocyanate, 1,3- or 1,4-phenylene diisocyanate, tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, methylene triphenyl triisocyanate (MIT), phthalic acid bis-isocyanatoethyl ester, trimethylhexamethylene diisocyanate, 1,4-diisocyanatobutane, 1,12-diisocyanatododecane, and dimer fatty acid diisocyanate.

Suitable at least trifunctional isocyanates are polyisocyanates which are obtained by trimerization or oligomerization of diisocyanates or by reaction of diisocyanates with low molecular weight polyfunctional compounds containing hydroxyl or amino groups. Commercially obtainable examples are trimerization products of the isocyanates HDI, MDI or IPDI or adducts of diisocyanates and low molecular weight triols, such as trimethylolpropane or glycerol. Further examples include isocyanurates of hexamethylene diisocyanate (HDI) and isocyanurates of isophorone diisocyanate (IPDI).

Aliphatic, cycloaliphatic, or aromatic isocyanates may in principle be used, but aromatic diisocyanates are particularly suitable. Examples of suitable diisocyanates include methylene diphenyl diisocyanates (MDIs) such as 4,4-methylene diphenyl diisocyanate, 2,4-methylene diphenyl diisocyanate, or 2,2-methylene diphenyl diisocyanate. The PU adhesives according to the present invention may contain the isocyanates in reacted form as PU prepolymers or they contain at least a proportion of low molecular weight—optionally oligomeric—isocyanates.

PU prepolymers may be produced in a known manner from the above-mentioned polyols and polyisocyanates. A prepolymer containing NCO groups may here be produced from the polyols and isocyanates. Examples thereof are described in EP-A 951493, EP-A 1341832, EP-A 150444, EP-A 1456265, and WO 2005/097861.

The at least one NCO-terminated PU prepolymer is preferably an aromatic isocyanate-terminated—still more preferably, MDI-terminated—polyurethane prepolymer made of a polyether/polyester polyol mixture and an aromatic diisocyanate such as MDI.

The corresponding prepolymers typically have an NCO content of 5-20 wt % (determined according to Spiegelberger, DIN EN ISO 1 1909:2007-05), and have a mean NCO functionality of 2 to 3.

Due to the excess isocyanate used, the NCO-terminated PU prepolymers usually have certain amounts of isocyanate monomers, i.e., in particular, aromatic polyisocyanate monomers, such as, for example, MDI, typically in amounts of 0.1 to 25 wt % in relation to the total weight of prepolymers and monomers.

The molecular weight (Mn) of the prepolymer is in the range of 1500 to 100,000 g/mol, particularly preferably from 2000 to 50,000 g/mol.

In addition to the resin component, the binder system according to the present invention also contains a curative component. The curative component contains, in particular, one or more polyols.

Suitable polyols are aliphatic and/or aromatic alcohols with 2 to 6, preferably 2 to 4, OH groups per molecule. The OH groups may be both primary and secondary.

Suitable aliphatic alcohols include, for example, ethylene glycol, propylene glycol, 1,4-butanediol, 1,5-pentanediol, 1,6-hexanediol, 1,7-heptanediol, 1,8-octanediol and the higher homologues or isomers thereof. More highly functional alcohols are likewise suitable, such as for example glycerol, trimethylolpropane, pentaerythritol and oligomeric ethers of the stated substances.

Reaction products of low molecular weight polyfunctional alcohols with alkylene oxides are preferably used as the polyol component. The alkylene oxides preferably have 2 to 4 C atoms. The reaction products of ethylene glycol, propylene glycol, the isomeric butanediols, hexanediol or 4,4′-dihydroxydiphenylpropane with ethylene oxide, propylene oxide or butylene oxide, or mixtures of two or more thereof are, for example, suitable. The reaction products of polyfunctional alcohols, such as glycerol, trimethylolethane, or trimethylolpropane, pentaerythritol or sugar alcohols, or mixtures of two or more thereof, with the stated alkylene oxides to form polyether polyols are furthermore also suitable. Further polyols usual for the purposes of the invention are obtained by polymerization of tetrahydrofuran (poly-THF). Polyethers which have been modified by vinyl polymers are likewise suitable for use as the polyol component. Such products are for example obtainable by polymerizing styrene or acrylonitrile or a mixture thereof in the presence of polyethers.

Further suitable polyols are polyester polyols.

Examples of these are polyester polyols, which are obtained by reacting low molecular weight alcohols, in particular ethylene glycol, diethylene glycol, neopentyl glycol, hexanediol, butanediol, propylene glycol, glycerol, or trimethylolpropane with caprolactone.

Other suitable polyester polyols can be produced by polycondensation. Such polyester polyols preferably comprise the reaction products of polyfunctional, preferably difunctional alcohols and polyfunctional, preferably difunctional and/or trifunctional carboxylic acids or polycarboxylic anhydrides. Compounds suitable for producing such polyester polyols are in particular hexanediol, 1,4-hydroxymethylcyclohexane, 2-methyl-1,3-propanediol, 1,2,4-butanetriol, triethylene glycol, tetraethylene glycol, ethylene glycol, polyethylene glycol, dipropylene glycol, polypropylene glycol, dibutylene glycol and polybutylene glycol. Proportions of trifunctional alcohols may also be added.

The polycarboxylic acids may be aliphatic, cycloaliphatic, aromatic, or heterocyclic, or both. They may optionally be substituted, for example by alkyl groups, alkenyl groups, ether groups, or halogens. Suitable polycarboxylic acids are for example succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, glutaric anhydride, maleic acid, maleic anhydride, fumaric acid, dimer fatty acid, or trimer fatty acid, or mixtures of two or more thereof. Proportions of tricarboxylic acids may optionally also be added.

It is, however, also possible to use polyester polyols of oleochemical origin. Such polyester polyols may for example be produced by complete ring opening of epoxidized triglycerides of a fat mixture containing at least in part an olefinically unsaturated fatty acid with one or more alcohols having 1 to 12 C atoms and subsequent partial transesterification of the triglyceride derivatives to yield alkyl ester polyols having 1 to 12 C atoms in the alkyl residue. Further suitable polyols are polycarbonate polyols and dimer diols (from Henkel) and castor oil and the derivatives thereof. Hydroxy-functional polybutadienes, as are for example available under the trade name poly-BD®, may be used as polyols for the compositions according to the present invention.

Polyacetals are likewise suitable as the polyol component. Polyacetals are taken to mean compounds as are obtainable from glycols, for example diethylene glycol or hexanediol or mixtures thereof, with formaldehyde. Polyacetals which are usable for the purposes of the invention may likewise be obtained by polymerization of cyclic acetals. Polycarbonates are furthermore suitable as polyols. Polycarbonates may, for example, be obtained by the reaction of diols, such as propylene glycol, 1,4-butanediol or 1,6-hexanediol, diethylene glycol, triethylene glycol or tetraethylene glycol or mixtures of two or more thereof with diaryl carbonates, for example diphenyl carbonate, or phosgene. Hydroxy esters of polylactones are likewise suitable.

Another group of polyols may be OH-functional polyurethane polyols, e.g., OH-terminated polyurethane prepolymers.

Polyacrylates bearing OH groups are likewise suitable as a polyol component. These polyacrylates may, for example, be obtained by the polymerization of ethylenically unsaturated monomers which bear an OH group. Ethylenically unsaturated carboxylic acids suitable for this purpose are for example acrylic acid, methacrylic acid, crotonic acid or maleic acid or the esters thereof with C1 to C2 alcohols. Corresponding esters bearing OH groups are for example 2-hydroxyethyl acrylate, 2-hydroxyethyl methacrylate, 2-hydroxypropyl acrylate, 2-hydroxypropyl acrylate, 2-hydroxypropyl methacrylate, 3-hydroxypropyl acrylate, or 3-hydroxypropyl methacrylate, or mixtures of two or more thereof.

The binder system described herein may, in different embodiments, further contain at least one catalyst, in particular, selected from Sn- or Ti-based metal catalysts or amine catalysts. Suitable catalysts are known in the prior art. The catalyst is preferably contained in the curative component, i.e., in the hydroxy-functionalized component in the systems that are preferred according to the present invention.

The adhesive according to the present invention may also contain the usual additives. Further components entail, for example, resins (tackifiers), stabilizers, cross-linking agents or viscosity regulators, pigments, plasticizers, or antioxidants.

The polyurethane adhesives according to the present invention are liquid at application temperatures, either at room temperature or as a hot-melt adhesive. It is preferable for the PU adhesives according to the present invention to be liquid at room temperature. The compositions described herein have, in different embodiments, a viscosity of 500 to 100,000, in particular, 1,000 to 20,000 mPas at a temperature of 40° C., as determined according to DIN ISO 2555 (Brookfield viscometer RVT, spindle nr. 4, 25° C.; 5 UpM).

The adhesives described herein may contain solvents or may be solvent-free. Basically, all solvents known to the person skilled in the art can be used as the solvent, particularly esters, ketones, halogenated hydrocarbons, alkanes, alkenes and aromatic hydrocarbons. Exemplary solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, di-isobutyl ketone, dioxane, ethyl acetate, ethylene glycol monobutyl ether acetate, ethylene glycol monoethyl acetate, 2-ethylhexyl acetate, glycol diacetate, heptane, hexane, isobutyl acetate, isooctane, isopropyl acetate, methyl ethyl ketone, tetrahydrofuran, or tetrachloroethylene, or mixtures of two or more of the cited solvents.

The adhesives may be applied to the adherend substrates—in particular, films—with the conventional equipment and all of the commonly used application methods, for example, by spraying, doctoring, a ¾-roller coating mechanism in the case of the use of a solvent-free system, or a 2-roller coating mechanism in the case of the use of a solvent-containing system. After application, the adherend substrates are adhered to one another in a known manner. It is then appropriate to use elevated temperatures if necessary in order to achieve a better application and more rapid cross-linking reaction. However, the adhesives according to the present invention already exhibit a very favorable curing at room temperature or only slightly elevated temperatures, such as 40° C.

The polyurethane adhesives according to the present invention are in particular suitable as laminating adhesives. They may be used in a process in which known films based on polymers, such as PP, PE, OPA, polyamide, PET, polyester, or metal foils are bonded to one another. The adhesive according to the present invention is here applied onto an optionally pretreated or printed film. The quantity applied is then usually 1 to 5 g/m². This may proceed at elevated temperature in order to obtain a thin and uniform coating. A second film of identical or different material is then laminated thereon under pressure. Heat may be applied, to crosslink the adhesive and obtain a multilayer film. The multilayer film may optionally also be composed of more than two layers.

The films are conventionally placed in storage after production. During this time, the adhesives according to the present invention may crosslink further.

Thanks to the use of the liquid or hot-melt adhesives according to the present invention as the laminating adhesive, it is possible to obtain laminated two-layer or multilayer films which meet the stringent requirements for suitability for foodstuffs or medical packaging.

It shall be readily understood that all embodiments disclosed herein in connection with the PU adhesive can also be used for the uses and methods described, and vice versa.

The present invention shall be described in greater detail below, with reference to several exemplary embodiments. The quantities set forth are wt %, unless otherwise stated.

### EXAMPLES

### Example 1 (According to the Present Invention)

Resin base:

NCO-terminated MDI prepolymer with an NCO content of 10 to 15 wt %.

Curing agent:

30 wt % trifunctional polypropylene glycol (PPG) with Mw=1000 g/mol; 5 wt % trifunctional PPG with Mw=450 g/mol; 5 wt % dipropylene glycol; 60 wt % calcium carbonate (×5≧0.1 μm, ×10≦0.3 μm, ×50≦1.5 μm, and ×90≦4 μm).

Resin:curing agent mixing ratio: 100:120 parts by weight

Filler content in the mixture: 27 wt %

### Example 2 (According to the Present Invention)

Resin base:

NCO-terminated MDI prepolymer with an NCO content of 10 to 15 wt %.

Curing agent:

20 wt % trifunctional polypropylene glycol (PPG) with Mw=1000 g/mol; 20 wt % difunctional polyester with Mw=2000 g/mol; 5 wt % trifunctional PPG with Mw=450 g/mol; 5 wt % dipropylene glycol; 50 wt % calcium carbonate (×5≧0.1 μm, ×10≦0.3 μm, ×50≦1.5 μm, and ×90≦4 μm).

Resin:curing agent mixing ratio: 100:100 parts by weight

Filler content in the mixture: 25 wt %

### Example 3 (Comparative Example)

Resin base:

NCO-terminated MDI prepolymer with an NCO content of 10 to 15 wt %.

Curing agent: 30 wt % trifunctional polypropylene glycol (PPG) with Mw=1000 g/mol; 30 wt % difunctional polyester with Mw=2000 g/mol; 5 wt % trifunctional PPG with Mw=450 g/mol; 5 wt % dipropylene glycol; 30 wt % calcium carbonate (×50=4.9 μm, and ×90=25 μm).

Resin:curing agent mixing ratio: 100:100 parts by weight

Filler content in the mixture: 15 wt %

### Example 4 (Comparative Example)

Resin base:

NCO-terminated MDI prepolymer with an NCO content of 10 to 15 wt %.

Curing agent: 80 wt % trifunctional polypropylene glycol (PPG) with Mw=1000 g/mol; 10 wt % trifunctional PPG with Mw=450 g/mol; 10 wt % dipropylene glycol;

Resin:curing agent mixing ratio: 100:50 parts by weight

Filler content in the mixture: 0 wt %

Composite Film:

The composite films are produced with the aid of a Super Combi 2000 laminating device. Then, 2 g/m² of the adhesive composition is applied to the film (OPA or metOPP) to be adhered, and this film is then laminated under pressure onto the second film (PE or OPP). The acting roller pressure of the laminating work corresponds to a force of up to 200 N (20 kg).

Bonding Adhesion:

The bonding adhesion is determined in accordance with the standard DIN 53357 after 14 days of curing at room temperature, by means of a tensile testing machine from Instron (Instron 4301). For this purpose, sample strips of the composite film (sample width of 15 mm) were loaded between clamping jaws and then pulled apart at a pull-apart speed of 100 m/min, a pull-apart angle of 90°, and a pull-apart length of 5 to 10 cm. The mean value of a determination in triplicate of the maximum force to be applied is indicated in relation to the sample width of 15 mm.

Elongation at Tear and Tearing Tension:

The elongation at tear and the tearing tension are determined according to the standard DIN 53504 (S2).

Primary Aromatic Amine (PAA) Content:

The wait time after the films are bonded until the adhesive is considered “essentially migration-free” is indicated. This is then the case when the primary aromatic amine (PAA) content is lower than 1.0 μg/100 mL filling. 3% acetic acid is used as filling or filling simulator. An OPA/PE laminate produced by means of the adhesive, which surrounds the filling due to heat sealing, is used as packaging, wherein the PE side forms the inner side of the packaging and the inner side of the sealing seam. The primary aromatic amine content is determined according to §64 of the German Code on foodstuffs, consumer items and animal feed (Lebensmittel-, Bedarfsgegenstände- and Futtermittelgesetzbuch, LFGB) according to method L 00.006.

Composite Materials:

OPA: oriented polyamide

PE: Polyethylene

OPP: oriented polypropylene

metOPP: metallized OPP (OPP coated with aluminum)

TABLE 1

| | Example 1 | Example 2 | | |
|---|---|---|---|---|
| | (according to | (according to | Example 3 | Example 4 |
| | the present | the present | (Comparative | (Comparative |
| | invention) | invention) | example) | example) |
| Bonding | 4.1 | 5.0 | not | 5.0 |
| adhesion at | | | measurable; | |
| N/15 mm on | | | no laminates | |
| OPA/PE | | | can be | |
| | | | produced | |
| Bonding | 1.4 | 1.8 | not | 1.8 |
| adhesion at | | | measurable; | |
| N/15 mm | | | no laminates | |
| on OPP/ | | | can be | |
| metOPP | | | produced | |
| Tearing tension | 8.5 | 12.0 | — | 5.5 |
| in MPa | | | | |
| Elongation at | 400 | 350 | — | 400 |
| tear in % | | | | |
| PAA content | 6 days | 6 days | — | 8 days |
| <1.0 μg/ | | | | |
| 100 mL | | | | |
| Sedimentation/ | none | none | intense | — |
| phase | | | | |
| separation | | | | |
| Abrasiveness | low | low | high | — |
| on laminating | | | | |
| rollers | | | | |

1. A polyurethane-based laminating adhesive composition, comprising
an isocyanate functional component;
an isocyanate reactive component; and
5 to 50 wt %, relative to the total weight of the laminating adhesive composition, of at least one solid particulate filler, wherein,
i) at least 90% of the filler particles of the at least one solid particulate filler have a particle size of 4 μm or less, and
ii) the at least one solid particulate filler has a Mohs hardness of 3 or less.

2. The laminating adhesive composition according to claim 1, containing 10 to 40 wt % of at least one solid particulate filler.

3. The laminating adhesive composition according to claim 1, containing 20 to 30 wt % of at least one solid particulate filler.

4. The laminating adhesive composition according to claim 1, comprising a molar ratio of NCO groups to OH groups of 1:1 to 1.8:1.

5. The laminating adhesive composition according to claim 1, comprising a molar ratio of NCO groups to OH groups of 1.05:1 to 1.5:1.

6. The laminating adhesive composition according to claim 1, wherein the at least one filler has a particle size distribution of ×10≦0.3 μm, ×50≦1.5 μm, and ×90≦4 μm.

7. The laminating adhesive composition according to claim 1, wherein the at least one filler has an oil absorption value of 50 or less.

8. The laminating adhesive composition according to claim 1, wherein the at least one filler has an oil absorption value of 40 or less.

9. The laminating adhesive composition according to claim 1, wherein the filler is selected from the group consisting of calcium carbonate, calcium sulfate, dolomite, and mixtures thereof.

10. The laminating adhesive composition according to claim 1, wherein the laminating adhesive composition is a two-component polyurethane adhesive, and
a) the isocyanate reactive component comprises a hydroxy-terminated polyurethane prepolymer and the isocyanate functional component comprises a polyisocyanate, or
b) the isocyanate functional component comprises an isocyanate terminated polyurethane prepolymer and the isocyanate reactive component comprises a polyol.

11. The laminating adhesive composition according to claim 1, wherein the filler is contained either in the isocyanate functional component or in the isocyanate reactive component.

12. The laminating adhesive composition according to claim 1, wherein:
a) the composition further contains at least one catalyst selected from Sn- or Ti-based metal catalysts or amine catalysts, and/or
b) the composition has a viscosity of 500 to 100,000 at a temperature of 40° C., and/or
c) the composition contains a filler having a maximum 5% content of filler particles with a particle size ≦0.1 μm, relative to the filler, and/or
d) the composition is essentially free of organic solvents.

13. The laminating adhesive composition according to claim 1, wherein:
a) the composition further contains at least one catalyst selected from Sn- or Ti-based metal catalysts or amine catalysts, and/or
b) the composition has a viscosity of 1,000 to 20,000 mPas at a temperature of 40° C., and/or
c) the composition contains a filler having a maximum 5% content of filler particles with a particle size ≦0.1 μm, relative to the filler, and/or
d) the composition is essentially free of organic solvents.

14. A multilayer film comprising a plurality of polymeric films or metal foils bonded together by the laminating adhesive composition according to claim 1.

15. A packaging for medicines or foodstuffs comprising the multilayer film of claim 11 sealed around a medicine or a foodstuff.

16. A method for producing composite films, comprising:
providing a first substrate having a surface;
disposing the polyurethane-based laminating adhesive composition of claim 1 on at least part of the first substrate surface;
providing a second substrate having a surface;
laminating the second substrate surface over the first substrate surface wherein the polyurethane-based laminating adhesive composition is in contact with at least portions of both the first substrate surface and the second substrate surface; and
curing the polyurethane-based laminating adhesive composition to bond the first substrate to the second substrate.

17. The method according to claim 13, wherein the polyurethane-based laminating adhesive composition of claim 1 is disposed in an amount of 1 to 5 g/m² on the first substrate surface.
